(19) United States
(12) Patent Application Publication
(10) Pub. No.: US 2025/0051150 A1
(43) Pub. Date: Feb. 13, 2025

(54) METHOD AND APPARATUS FOR A CUSHIONING FORKLIFT BUMPER ASSEMBLY

(71) Applicant: IAA Holdings, LLC, Lincoln, NE (US)

(72) Inventors: Billy Windell Butler, Westchester, IL (US); Mark Woods, Westchester, IL (US); Chester Bourdeau, Westchester, IL (US)

(73) Assignee: IAA Holdings, LLC, Lincoln, NE (US)

(21) Appl. No.: 18/366,100

(22) Filed: Aug. 7, 2023

(51) Int. Cl. B66F 9/12

(52) U.S. Cl. CPC B66F 9/12

(57) ABSTRACT

A cushioning bumper assembly for a forklift includes one or more cushioning bumper members assembled from a belting material wrapped around a cylindrical compressible material. The cushioning bumper members are secured to a fastener, such as an elongated box tubing which may be secured to the shank of the forklift to position the bumper members at a desired height and position forward of the shank.

### FIELD

The disclosure relates generally to fork lifts, and more particularly to fork lifts used to transport heavy objects such as vehicles.

### BACKGROUND

Forklifts, sometimes also referred to as forkloaders, are used to lift and move objects in a variety of settings. Forklifts may be used indoors, for example in a warehouse, or outdoors. Forklifts may be used to move pallets loaded with finished products, partially processed materials, raw materials, recyclable materials, and the like from one location to another. A forklift may also be useful in lifting and moving vehicles, especially for vehicle that may be non-operational.

A forklift typically includes a pair of tines or forks. Each tine has a horizontal portion called a blade and a vertical portion called a shank. The blade and the shank meet at a heel. The bottom of the blade may have a taper that decreases the thickness of the blade as the tip of the blade is approached. The taper may extend over a part of the blade or over the full blade.

Modern vehicles typically include a front and rear bumper portion intended to absorb impact during a collision, as well as styling and aerodynamic features, such as a spoiler, diffuser, air deflector, air dam or air curtain, near, around or under the front or rear bumper of the vehicle. Such styling and aerodynamic features are typically fabricated from plastic, carbon fiber or fiberglass, and may be relatively easily damaged. When a conventional forklift is used to transport a vehicle, the styling and aerodynamic features of the vehicle may be damaged when they impact with the shank of the forklift. Rubber protective covers on the shank of a forklift are similarly deficient in protecting the styling and aerodynamic features of a vehicle, and a likely to result in damage to the bumper and other features of the vehicle, especially when the relatively heavy weight of the vehicle impacts the shank, even with a protective cover.

### BRIEF SUMMARY

A cushioning bumper assembly for a forklift includes a cushioning bumper member having a cylindrical volume of compressible material wrapped within a belting material, which is fastened to an elongated fastener attached to the shank of the forklift.

The fastener and the edges of the belting material may have holes to accommodate fasteners to secure the belting material and the cylinder of compressible material to the elongated fastener. The elongated fastener may be box tubing.

The cushioning bumper assembly may include two or more cushioning bumper members disposed at different lateral position of the shank of the forklift.

The cylinder of compressible material may be closed-cell foam, which may be comprised of at least one of ethylene propylene diene monomer (EPDM) rubber, neoprene (CR), neoprene blend(s), styrene-butadiene rubber (SBR), EPDM/CR/SBR blend, polyvinyl chloride (PVC)/nitrile (NBR) blend, PVC/NBR/CR blend, polyurethane, silicone, low-density polyethylene, high-density polyethylene, cross-linked polyethylene (XLPE), ethylene-vinyl acetate (EVA), fluoroelastomer, or epichlorohydrin rubber. The cylinder can be formed from sheets of compressible material that are wrapped or rolled, and can be adhered together by an adhesive or heat pressing, into the shape of a cylinder. The density of the foam may be about 1 to 2 pounds per cubic feet, and may be about 1.7 pounds per cubic foot in an embodiment.

The cushioning bumper assembly may be positioned a certain distance above the fork of the forklift so more delicate front features of a vehicle, such as an airdam, fit underneath and avoid impacting the cushioning bumper assembly. The cushioning bumper assembly may be positioned generally parallel with and in front of the shank.

### BRIEF DESCRIPTION OF THE DRAWINGS

FIG. 1 illustrates a perspective view of a vehicle forklift with a bumper assembly in accordance with an embodiment;

FIG. 2 depicts a vehicle on a forklift equipped with a bumper in accordance with one or more embodiments.

FIG. 3 depicts a top view of FIG. 2.

FIG. 4 depicts a front view of a bumper in accordance with one or more embodiments.

FIG. 5 depicts a top view of a bumper in accordance with one or more embodiments.

FIG. 6 depicts a perspective view of a bumper in accordance with one or more embodiments.

FIG. 7 depicts a bumper mounted on a forklift in accordance with one or more embodiments.

FIG. 8 presents a flowchart describing a method of manufacturing or assembling a bumper assembly in accordance with one or more embodiments.

### DETAILED DESCRIPTION

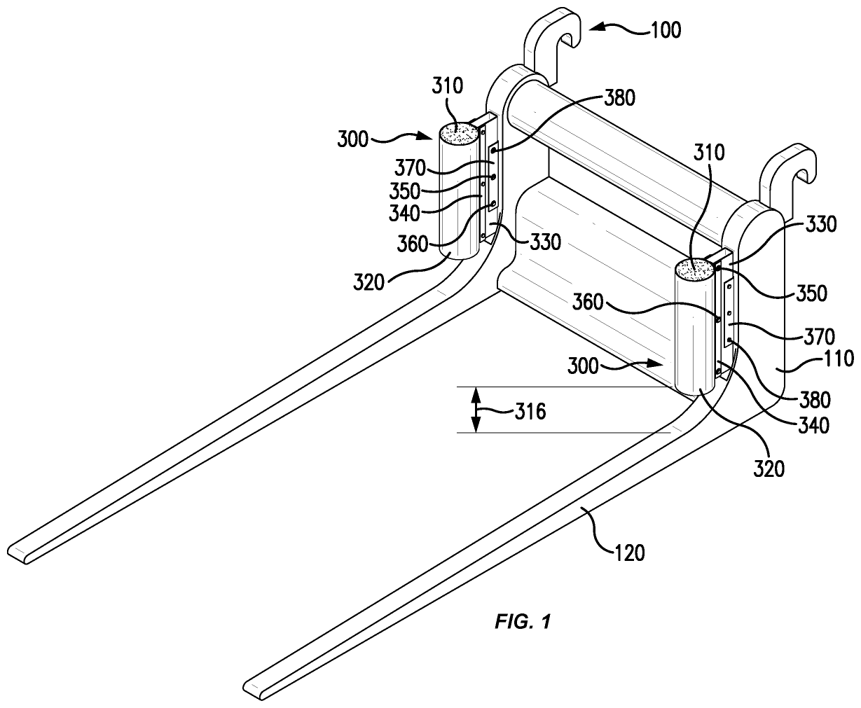

Referring to FIG. 1, a forklift 100 adapted with a bumper assembly according to an embodiment is illustrated. The forklift 100 typically has two tines, each including a generally vertical portion, or shank 110, and a generally horizontal portion, or blade 120. The blades 120 may extend from 3 to 6 or even 18 feet in some cases, depending upon the object to be lifted and transported. According to an embodiment, the forklift 100 is provided with a bumper assembly, comprising, in the illustrated embodiment, a pair of generally cylindrical cushioning bumper members 300 arranged generally vertically and parallel to the shank 100 of the forklift 100. In other embodiments, such as, for example, where the forklift 100 may be particularly wide, more than just cushioning bumper members 300 may be provided, such as 3 or 4 cushioning bumper members 300 spaced apart near the shank 110 of the forklift 100. In another embodiment, the multiple cushioning bumper members 300 may be provided in different arrangement, such as, for example, two pairs of cushioning bumper members 300, where each pair includes two cushioning bumper members 300 disposed next to each other, and the two pairs are disposed spaced apart along the shank 110. Such an arrangement could be used for a vehicle which is particularly large or heavy and would require additional cushioning protection.

According to an embodiment, each cushioning bumper member 300 may be secured to the forklift 100. For example, as illustrated in FIG. 1, the cushioning bumper members 300 may be secured with a bracket 330 attached to the shank 110 of the forklift 100. In an embodiment, the cushioning bumper member may include a generally cylindrical cushioning material 310, as well as belting material 320 wrapped around the cushioning material 310. The length of the belting material 320 may correspond to the length of the cushioning material 310, or, according to a different arrangement, the length of the belting material 320 may be shorter or longer than the length of the cushioning material 310. As illustrated, the belting material 320 may be securely wrapped around the cushioning material 310, and the belting material 320, with the cushioning material 310 enclosed, may be fixed to the bracket 330 attached to the shank 110 of the forklift 100. According to an alternative arrangement, the belting material 320, with the cushioning material 310 enclosed, could be secured directly to the shank 110 or other portion of the forklift 100 with any number securing mechanisms, such as bolts or rivets or other securing mechanism.

The size of the vehicle 200 that the forklift may lift and transport may vary. The vehicle 200 may be an automobile such as a sedan or SUV, or may be a pickup truck, a truck, and the like. Other loads may also be lifted by a forklift, such as a boat, or other objects that need protective cushioning during lifting or transport. In lifting and/or moving the vehicle 200 or other objects with a forklift 100, the bumper assembly may provide cushioning protection to protect the vehicle 200 from damage that could otherwise occur through direct contact with the shanks or other vertical portions of the forklift 100 such as a backrest (not shown), which is oriented parallel to the shanks 110 and disposed between and/or above the shanks 110.

Some objects, such as vehicles like sports cars, sedans or SUVs, may include a bumper, as well as more delicate airfoils, splitters, deflectors or other aerodynamic or styling features that extend below and forward of the bumper of the vehicle. In order to avoid such vehicle features from directly impacting the cushioning bumper members and possibly resulting in damage to the features, according to an embodiment, the bumper assembly, provided by the cushioning bumper members 300, may be elevated and positioned above the tines of the forklift to provide a gap for the extending aerodynamic or styling features, while the bumper of the vehicle rests against the cushioning bumper members 300.

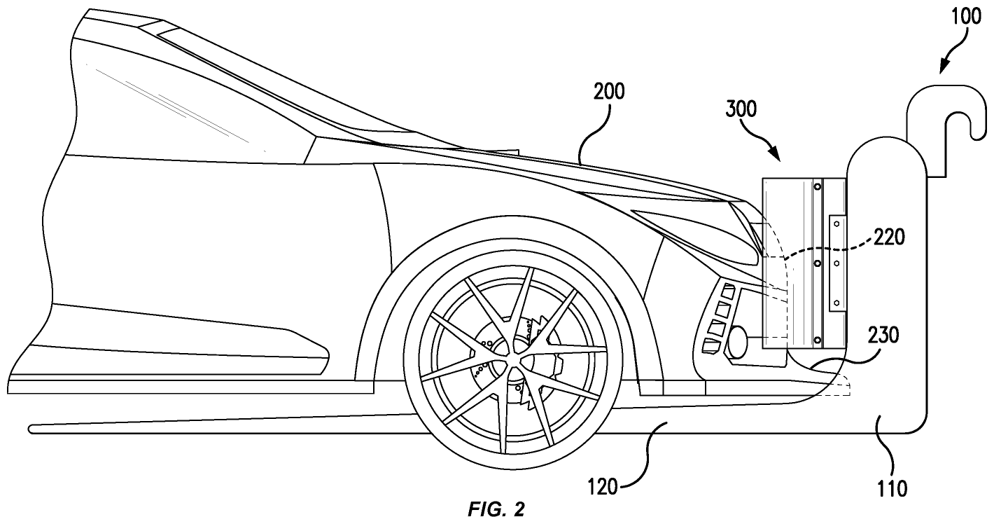

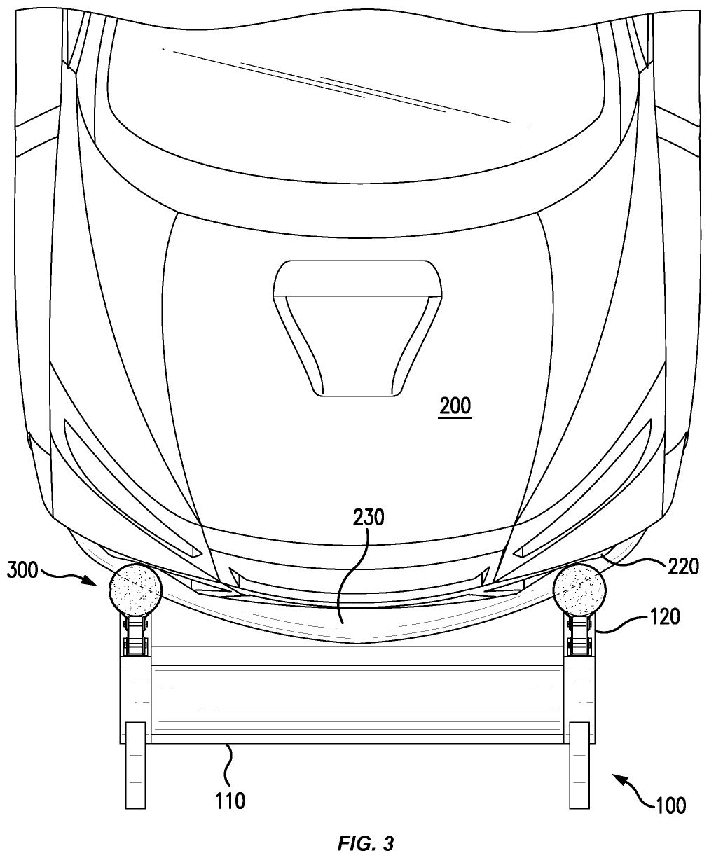

FIGS. 2 and 3 illustrate such an arrangement where the vehicle 200 includes a feature 230 that is lower than and that extends forward of the bumper 220 of the vehicle 200. The cushioning bumper member 300 of positioned a distance 316 above the tines 120 of the forklift 100. The bumper 220 of the vehicle rests against and is cushioned by the cushioning bumper member 300, while the extending feature 230 of the vehicle 200 avoids impacting the cushioning bumper member 300, avoiding potential damage.

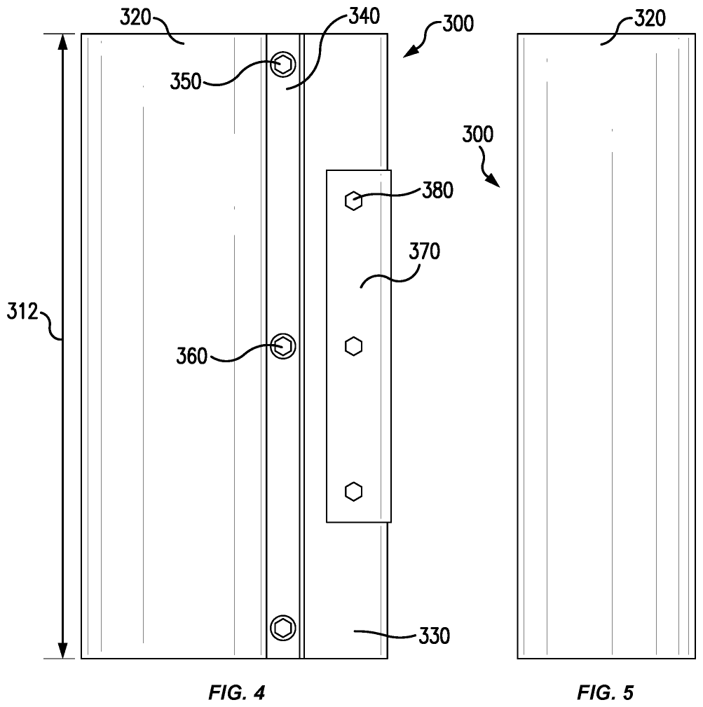

As illustrated in FIGS. 4-7 and other Figures as well, the cushioning bumper member 300 includes a compressible material 310 in a generally cylindrical shape, having a height 312 and a diameter 314. The height 312 of the compressible material in the shape of a cylinder 310 may be in the range of 18 to 24 inches while the diameter 314 may range between 8 to 10 inches. Other dimensions, larger or small, for the height 312 and the diameter 314, as well as other shapes may also be possible according to different embodiments. According to an embodiment, the compressible material 310 may be an open-cell foam or a closed-cell foam or any other suitable material. The foam may include one or more of ethylene propylene diene monomer (EPDM) rubber, neoprene (CR), neoprene blend(s), styrene-butadiene rubber (SBR), EPDM/CR/SBR blend, polyvinyl chloride (PVC)/nitrile (NBR) blend, PVC/NBR/CR blend, polyurethane, silicone, low-density polyethylene, high-density polyethylene, cross-linked polyethylene (XLPE), ethylene-vinyl acetate (EVA), fluoroelastomer, or epichlorohydrin rubber. The compressible material 310 may have a density in the range of 1 to 2 lbs. per cubic foot, or may be higher or lower according to different embodiments.

The compressible material in the shape of a cylinder 310 may, according to an embodiment, be made of one or more sheets of compressible material wrapped around itself to form the cylinder. In another embodiment, the compressible material may be formed from a long sheet that is rolled on itself to into the shape of a cylinder. The sheets may be rectangular in shape, with a dimension that corresponds to the height of the cylinder 310 and other dimension that is determined based upon the thickness of the sheet and the desired diameter of the cylinder, based upon rolling or wrapping the sheets together. In an embodiment, the dimension of the sheet that corresponds to the height of the cylinder may be between 1 foot to 3 foot, and may be longer or shorter in some embodiments. The thickness of each sheet may range between ¼ and ½ inch, although other suitable thicknesses may be used. An adhesive may be used to join adjacent sheet surfaces, or in some embodiments, bolts may be used to join the sheets.

According to an embodiment, constructing the cylinder 310 from one or more sheets of compressible material may include heat pressing one sheet to another. Heat pressing may include applying both heat and pressure to the sheets to be adhered or fused together. Heat pressing may be performed on flat sheets of compressible material before being wrapped or rolled into a cylinder or after the wrapping or rolled has occurred.

The belting material 320 may be made of material similar to conveyor belt material or other suitable material that is durable, will securely enclose the cylinder of compressible material and having at least one surface will be protective of the surface of a vehicle to avoid scratches or other damage. Specifically, the belting material 320 may be a rubber type conveyor bare-back belting such as that used in a quarry to transport gravel and other rock materials. In one or more embodiments, a the belting material 320 may be made from polyvinyl chloride and fabric such as polyester or styrene-butadiene rubber and several layers of polyester or nylon fabric. Before assembly, the belting material 320 may be in a rectangular shape. According to an embodiment, a plurality of holes that pass through the thickness of the belting material may be provided along two opposing edges. According to an embodiment, one dimension of the belting material 320 may correspond to the height 312 of the cylinder 310, and the other dimension will be determined by the circumference of the cylinder with additional belting material 320 used to secure the belting material around the cylinder 310 and onto the fork lift 100.

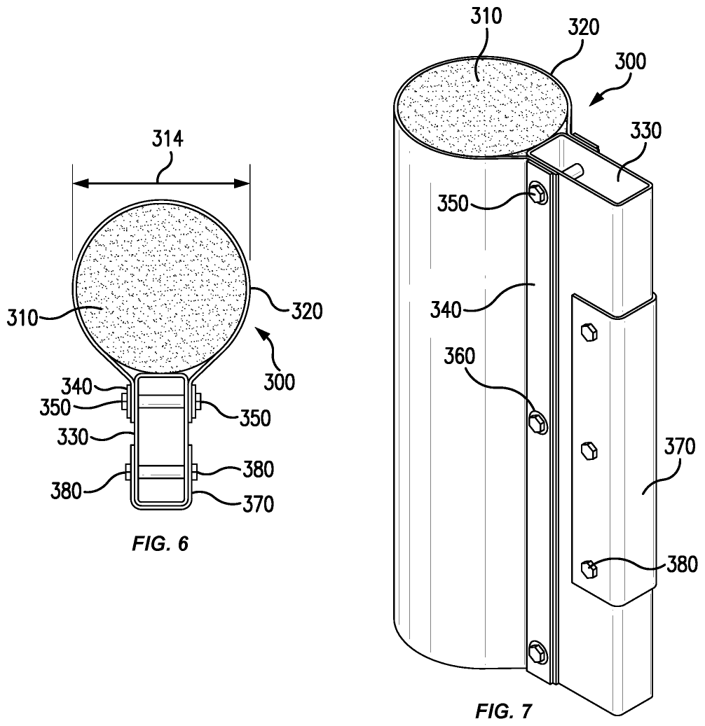

According to an embodiment, the belting material 320 enclosing the cylinder of compressible material 310 may be secured together by fastening the belting material 320 to a length of box tubing, as illustrated in FIGS. 5 and 6. The length of the box tubing 330 may be equal to the height 312 of the cylinder 310, or may be shorter or longer as well. The two sides of the box tubing 330 may include a plurality of holes corresponding to the holes in the belting material 320. The box tubing may be metal, metal alloy, plastic, or other suitable materials that can secure the belting material 320 and be securely affixed to the shank of the forklift.

A pair of strips 340 may be provided to help secure the belting material 320 to the box tubing 330. The strips 340 may be rectangular in shape and may be metal, metal alloy, plastic, or other suitable material that can be secured to the box tubing 330. Each strip 340 may include a plurality of holes that correspond to the holes in the belting material 320 and the plurality of holes in the box tubing 330. Each strip 340 may have a length that is equal to the height 312 of the cylinder 310, or at least long enough to extend the length of the holes in the box tubing 330. According to an embodiment, the width of each strip 340 may be between 1½ and 3 inches.

The cushioning bumper members 300 may be assembled by wrapping the belting material 320 around the cylinder 310. Each end of the belting material 320 may be placed between a side of the box tubing 330 and a respective strip 340, disposing these three components to align the holes of the belting material 320, the holes of the box tubing 330, and the holes of the strips 340. With the holes aligned, a bolt 350 may be passed through each set of aligned holes and secured, such as with a nut or other securing element. A single bolt 350 may pass through both strips 340 for each set of aligned holes. In one or more embodiments, washers 360 may be disposed between the head of one or more of the bolts 350 and the respective strip 340 and between the corresponding nut and the other respective strip 340. As the nuts are threaded on their respective bolts 350, the belting material 320 is tightened around the cylinder 310, pulling the cylinder 310 snuggly against the box tubing 330, and securing the cushioning bumper member 300.

To protect the vehicle 200 from potential damage from the forklift 100, especially the shank 110, including protecting parts of the vehicle 200 such as a lower deflector 230, the cushioning bumper members 300 are disposed in front of the shank a distance sufficient that the front of the vehicle 200 does not directly touch the shank 110, but instead, the bumper 220 of the vehicle rests against the cushioning bumper members 300. Further, according to an embodiment, the cushioning bumper members 300 may be positioned a distance 316 above the top of the blade 120 of the forklift 100 so that the cushioning bumper members 300 will make contact with the vehicle bumper 220 and will not contact the lower deflector 230 of the vehicle 200, which may be more susceptible to damage. The distance 316 of the bottom of the cushioning bumper member 300 above the blade 120 may be in the range of 4 to 8 inches. In other embodiments, the cushioning bumper members 300 may be positioned higher or lower, to accommodate vehicle or loads with bumpers at different heights or locations.

This height 316 may be set by mounting the box tubing 330 to the shank 110 by a U-shaped channel 370. The U-shaped channel 370 may be fixed to the shank 110 by welding, bolting, or some other suitable form of fastening. Each side of the channel 370 may include a plurality of holes on the sides of the channels 370. According to embodiment, the cushioning bumper members 300 may be secured to the shank 110 at the desired height by positioning the box tubing 330 in the channel 370 and passing a bolt 380 through each of the paired holes of the channel 370 as well as a pair of corresponding holes in the box tubing 330. A nut or other fastener may be threaded onto each bolt 380 until tight. In one or more embodiments, washers may be placed between the head of one or more bolts 380 and the channel 370 as well as between each corresponding nut (or other fastener) and the channel 370.

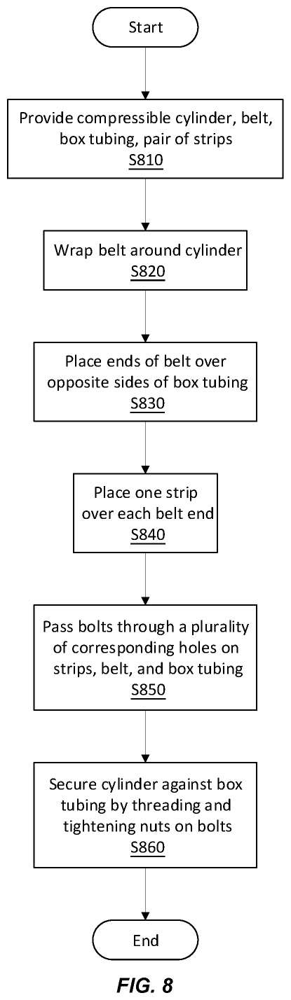

FIG. 8 describes, according to an embodiment, a method of assembly of a cushioning bumper assembly 300 for a forklift or similar machine, which may include providing a cylinder of compressible material, a belt, box tubing, a pair of rectangular strips, and pluralities of bolts, nuts, and in one or more embodiments, a U-shaped channel and/or washers.

According to one or more embodiments of the method, the cylinder may be formed by wrapping or rolling at least one sheet of compressible material into a cylinder. The compressible material may be a closed-cell foam, or alternatively a suitable open-cell foam. An adhesive may be applied to one or more surfaces of the at least one sheet of compressible material to join the surface to an adjacent surface of the at least one sheet. Adjacent sheet surfaces may also be fused by heat pressing.

The belting material may be formed of a rubber type conveyor bare-back belting. The belting material may have a width corresponding to the height of the cylinder of compressible material. Along edges of the belting material, a plurality of holes may be made through the thickness of the belt.

Box tubing may be formed in a rectangular shape with a first surface configured to contact the cylinder of compressible material. On each of the two surfaces adjacent to the first surface, a plurality of holes is formed corresponding to the plurality of holes in the belting material.

Strips may be provided that also have a plurality of holes formed in it that corresponds to the other pluralities of holes

The cushioning bumper assembly is assembled by wrapping the belting material around the cylinder, positioning each widthwise edge of the belt on opposite sides of the two sides of the box tubing adjacent to the side configured to contact the cylinder, passing a bolt or other fastener through each of the plurality of corresponding holes, threading a nut or other fastener on the bolt, and tightening to secure the cushioning bumper assembly. In one or more embodiments, one or more washers may be disposed on at least one of the bolts adjacent to the bolt head or the nut.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

As used herein, a rectangle is quadrilateral including four right angles. A square is a rectangle with four equal sides.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A cushioning bumper assembly for a forklift having at least one shank and at least one fork, the cushioning bumper assembly comprising:
at least a first cushioning bumper member comprised of:
a volume of compressible material formed substantially in the shape of a cylinder,
a sheet of belting material wrapped around the cylinder of compressible material,
an elongated fastener for securely fastening the belting material wrapped around the cylinder of compressive material, and wherein the elongated fastener is adapted to be attached at a position forward of the shank of the forklift.

2. The cushioning bumper assembly of claim 1, wherein a plurality of holes are provided in the elongated fastener and a corresponding plurality of holes are provided on opposed edges of the belting material, and a plurality of fastening members are inserted through the holes of the elongated fastener and the belting material to secure the cylinder and the belting material to the elongated fastener.

3. The cushioning bumper assembly of claim 1 further comprising a second cushioning bumper member, and the first cushioning bumper member and the second cushioning bumper member are positioned at different lateral positions of the shank of the forklift.

4. The cushioning bumper assembly of claim 1, wherein the compressible material comprises a closed-cell foam.

5. The cushioning bumper assembly of claim 4, wherein the closed cell foam comprises at least one of ethylene propylene diene monomer (EPDM) rubber, neoprene (CR), neoprene blend(s), styrene-butadiene rubber (SBR), EPDM/CR/SBR blend, polyvinyl chloride (PVC)/nitrile (NBR) blend, PVC/NBR/CR blend, polyurethane, silicone, low-density polyethylene, high-density polyethylene, cross-linked polyethylene (XLPE), ethylene-vinyl acetate (EVA), fluoroelastomer, or epichlorohydrin rubber.

6. The cushioning bumper assembly of claim 1, wherein the compressible material comprises at least one sheet of the compressible material which is wrapped or rolled to form the cylindrical shape.

7. The cushioning bumper assembly of claim 6, wherein adjacent surfaces of the wrapped or rolled sheet are adhered to each other by at least one of an adhesive or by heat pressing.

8. The cushioning bumper assembly of claim 1, wherein the compressible material comprises a density of between about 1 to 2 pounds per cubic foot.

9. The cushioning bumper assembly of claim 1, wherein the first cushioning bumper member is position a predetermined distance above a fork of the forklift.

10. The cushioning bumper assembly of claim 9 where the predetermined distance is between about 6 inches and 3 feet.

11. The cushioning bumper assembly of claim 1, wherein the first cushioning bumper member is disposed generally parallel with the shank of the forklift and extends between about 6 inches and 3 feet forward of the shank of the forklift.

12. The cushioning bumper assembly of claim 1, wherein the diameter of the cylinder is between about 6 inches and 24 inches.

13. The cushioning bumper assembly of claim 1, wherein the elongated fastener a box tubing.

14. The cushioning bumper assembly of claim 13 wherein the box tubing is secured in a channel attached to the shank.

15. The cushioning bumper assembly of claim 13 wherein the position of the box tubing is adjustable within the channel in order to adjust the height of the cushioning bumper assembly with respect of the fork of the forklift.

16. A cushioning bumper assembly for a forklift having at least two shanks and at least two forks, the cushioning bumper assembly comprising:
at least a first cushioning bumper unit and a second cushioning bumper unit, each of the first cushioning bumper unit and the second cushioning bumper unit comprising:
a cylinder of compressible material,
a sheet of belting material wrapped around at least a portion of the cylinder of compressible material, the sheet of belting material having a plurality of holes near opposed edges of the sheet,
at least a first and second box tubing having a plurality of holes complementary to the holes in the sheet of belting material,
a plurality of bolts securing in alignment the first and second cushioning bumper units to the first and second box tubing via the plurality of holes in the first and second cushioning bumper units and the first and second box tubing,
at least a first and a second channel attached to the shank of the forklift, the first and second channel securing the first and second box tubing, thereby positioning the first and second cushioning bumper units forward of shank and at a predetermined height.

17. The cushioning bumper assembly of claim 16 wherein the position of the first and second box tubing may be adjusted within the first and second channel to adjust the predetermined height of the first and second cushioning bumper assembly.

18. The cushioning bumper assembly of claim 16 wherein the compressible material comprises a closed-cell foam.

19. The cushioning bumper assembly of claim 16 wherein the compressible material comprises at least one sheet which is wrapped or rolled to form the cylinder.

20. The cushioning bumper assembly of claim 16 further comprising at least a first and second elongated strip with holes complementary to the holes in the first and second cushioning bumper units and the holes in the first and second box tubing, the first and second elongated strip secured in alignment, via the plurality of bolts, with the first and second cushioning bumper units and the first and second box tubing.
